(19) United States
(12) Patent Application Publication
(10) Pub. No.: US 2020/0334478 A1
(43) Pub. Date: Oct. 22, 2020

(54) OCCUPANT MONITORING APPARTUS AND APPLICATIONS THEREOF

(71) Applicant: GM GLOBAL TECHNOLOGY OPERATIONS LLC, DETROIT, MI (US)

(72) Inventors: Ron M. Hecht, Ra'anana (IL); Ariel Telpaz, Givat Haim Meuhad (IL); Kobi Nistel, Zoran (IL); Tzvi Philipp, Bet Shemesh (IL); Michael Baltaxe, Ra'anana (IL); Dan Levi, Kyriat Ono (IL)

(21) Appl. No.: 16/385,484

(22) Filed: Apr. 16, 2019

(51) Int. Cl. G06K 9/00; G06F 3/01

(52) U.S. Cl. CPC G06K 9/00845; G06F 3/013

(57) ABSTRACT

An occupant monitoring apparatus is provided. The apparatus includes a laser illuminator configured to emit a laser to illuminate an occupant; and a sensor configured to generate an image of the occupant illuminated by the laser.

### INTRODUCTION

Apparatuses and methods consistent with exemplary embodiments relate to occupant monitoring and recognition. More particularly, apparatuses and methods consistent with exemplary embodiments relate to occupant detection and gaze tracking.

### SUMMARY

One or more exemplary embodiments provide an occupant monitoring apparatus. More particularly, one or more exemplary embodiments provide an occupant monitoring apparatus with a laser illuminator.

According to an aspect of an exemplary embodiment, an occupant monitoring apparatus is provided. The apparatus includes a laser illuminator configured to emit a laser to illuminate an occupant; and a sensor configured to generate an image the occupant illuminated by the laser.

The apparatus may further include a controller configured to perform detection of the occupant and gaze tracking based on the image generated by the sensor.

The laser illuminator may further include one or more from among a polarized filter and a modulated polarized phase shifter.

The laser illuminator may be configured to transmit the laser light through the one or more from among the polarized filter and the modulated polarized phase shifter to the occupant.

The sensor may further include one or more from among a narrow band spectrum filter and a modulated polarized phase shifter.

The sensor is configured to receive the laser light reflected off the occupant through the one or more from among the narrow band spectrum filter and the modulated polarized phase shifter.

The laser illuminator may emit the laser with a wavelength of about 1550 nm.

The laser illuminator may emit the laser with a wavelength between 900 nm and 950 nm.

The sensor may include one or more from among a high dynamic resolution image sensor and a logarithmic sensor.

The sensor may include one or more from among a polarized filter and a pixel level polarization filter.

According to an aspect of an exemplary embodiment, an occupant monitoring apparatus is provided. The apparatus includes a laser illuminator configured to emit a laser to illuminate an occupant; and a sensor configured to generate an image the occupant illuminated by the laser; and a controller configured to control the sensor to record an image, the image corresponding to a known polarization state of an illuminator and a sensor, measure the signal to background noise ratio of the of the recorded image, determine whether the signal to background noise ratio of the recorded image is above a predetermined threshold ratio, in response to determining that the signal to background noise ratio is at or above the predetermined threshold, perform occupant detection and gaze estimation using the recorded image, in response to determining that the signal to background noise ratio is below the predetermined threshold, determine whether an adjustment limit is reached, and in response to determining that the adjustment limit has not been reached, control to adjust one or more from among polarization state and intensity of the illumination from the laser illuminator.

The controller may be further configured to, in response to determining that the adjustment limit is reached, use head pose as an estimate of a gaze direction of the occupant.

The laser illuminator may further comprise one or more from among a polarized filter and a modulated polarized phase shifter.

The laser illuminator may be configured to transmit the laser light through the one or more from among the polarized filter and the modulated polarized phase shifter to the occupant.

The sensor further may comprise one or more from among a narrow band spectrum filter and a modulated polarized phase shifter.

The sensor may be configured to receive the laser light reflected off the occupant through the one or more from among the narrow band spectrum filter and the modulated polarized phase shifter.

The laser illuminator may emit the laser with a wavelength of around 1550 nm.

The laser illuminator may emit the laser with a wavelength between 900 nm and 950 nm.

The sensor may include one or more from among a high dynamic resolution image sensor and a logarithmic sensor.

The sensor may include one or more from among a polarized filter and a pixel level polarization filter.

Other objects, advantages and novel features of the exemplary embodiments will become more apparent from the following detailed description of exemplary embodiments and the accompanying drawings.

### BRIEF DESCRIPTION OF THE DRAWINGS

The disclosed examples will hereinafter be described in conjunction with the following drawing figures, wherein like numerals denote like elements, and wherein:

FIG. 1 shows a block diagram of an occupant monitoring apparatus according to an exemplary embodiment;

FIG. 2 shows an illustration of an occupant monitoring apparatus according to an exemplary embodiment; and

FIG. 3 shows a method of performing occupant detection and gaze tracking using the occupant monitoring apparatus according to an aspect of an exemplary embodiment.

### DETAILED DESCRIPTION

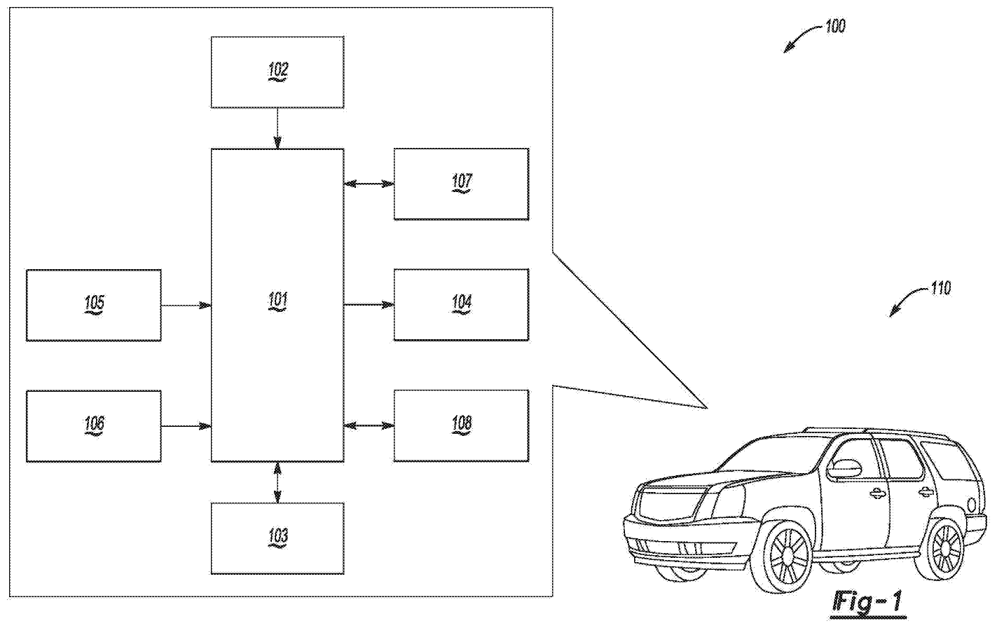

An occupant monitoring apparatus will now be described in detail with reference to FIGS. 1-3 of the accompanying drawings in which like reference numerals refer to like elements throughout.

The following disclosure will enable one skilled in the art to practice the inventive concept. However, the exemplary embodiments disclosed herein are merely exemplary and do not limit the inventive concept to exemplary embodiments described herein. Moreover, descriptions of features or aspects of each exemplary embodiment should typically be considered as available for aspects of other exemplary embodiments.

It is also understood that where it is stated herein that a first element is “connected to,” “attached to,” “formed on,” or “disposed on” a second element, the first element may be connected directly to, formed directly on or disposed directly on the second element or there may be intervening elements between the first element and the second element, unless it is stated that a first element is “directly” connected to, attached to, formed on, or disposed on the second element. In addition, if a first element is configured to “send” or “receive” information from a second element, the first element may send or receive the information directly to or from the second element, send or receive the information via a bus, send or receive the information via a network, or send or receive the information via intermediate elements, unless the first element is indicated to send or receive information “directly” to or from the second element.

Throughout the disclosure, one or more of the elements disclosed may be combined into a single device or into one or more devices. In addition, individual elements may be provided on separate devices.

Many vehicles are equipped with driver monitoring systems (DMS) that monitor the driver's attentiveness by detecting the gaze direction of the driver. Eye tracking may be used to monitor the driver's attentiveness via a dedicated detection and illumination system. However, in some environmental situations, e.g. direct sun light, may cause suboptimal operation of the DMS and may interfere with the image of the driver being sensed by the DMS.

To address the above issues, an occupant monitoring system, according to an exemplary embodiment, may include changing the light source from LEDs to laser illuminators, illuminate using wavelength that creates less ambient and solar background contribution or interference. In addition, narrower band pass filters may be used, the polarization orientation of illuminator may be modulated, and imaging sensors with selectable polarizations and filters may be applied to the occupant monitoring system.

FIG. 1 shows a block diagram of an occupant monitoring apparatus 100 according to an exemplary embodiment. As shown in FIG. 1, the occupant monitoring apparatus 100, according to an exemplary embodiment, includes a controller 101, a power supply 102, a storage 103, an output 104, a sensor 105, a user input 106, an illuminator 107, and a communication device 108. However, the occupant monitoring apparatus 100 is not limited to the aforementioned configuration and may be configured to include additional elements and/or omit one or more of the aforementioned elements. The occupant monitoring apparatus 100 may be implemented as part of a vehicle, as a standalone component, or as a hybrid between an on vehicle 110 and off vehicle device.

The controller 101 controls the overall operation and function of the occupant monitoring apparatus 100. The controller 101 may directly or indirectly control one or more of a power supply 102, a storage 103, an output 104, a sensor 105, a user input 106, an illuminator 107, and a communication device 108, of the occupant monitoring apparatus 100. The controller 101 may include one or more from among a processor, a microprocessor, a central processing unit (CPU), a graphics processor, Application Specific Integrated Circuits (ASICs), Field-Programmable Gate Arrays (FPGAs), state machines, circuitry, and a combination of hardware, software and firmware components.

The controller 101 is configured to send and/or receive information from one or more of the power supply 102, the storage 103, the output 104, the sensor 105, the user input 106, the illuminator 107, and the communication device 108 of the occupant monitoring apparatus 100. The information may be sent and received via a bus or network, or may be directly read or written to/from one or more of the power supply 102, the storage 103, the output 104, the sensor 105, the user input 106, the illuminator 107, and the communication device 108 of the occupant monitoring apparatus 100. Examples of suitable network connections include a controller area network (CAN), a media oriented system transfer (MOST), a local interconnection network (LIN), a local area network (LAN), wireless networks such as Bluetooth and 802.11, and other appropriate connections such as Ethernet.

The power supply 102 provides power to one or more of the storage 103, the output 104, the sensor 105, the user input 106, the illuminator 107, and the communication device 108, of the occupant monitoring apparatus 100. The power supply 102 may include one or more from among a battery, an outlet, a capacitor, a solar energy cell, a generator, a wind energy device, an alternator, etc. The storage 103 is configured for storing information and retrieving information used by the occupant monitoring apparatus 100.

The storage 103 may be controlled by the controller 101 to store and retrieve information received from one or more sensors 105 as well as computer or machine executable instructions. The storage 103 may include one or more from among floppy diskettes, optical disks, CD-ROMs (Compact Disc-Read Only Memories), magneto-optical disks, ROMs (Read Only Memories), RAMs (Random Access Memories), EPROMs (Erasable Programmable Read Only Memories), EEPROMs (Electrically Erasable Programmable Read Only Memories), magnetic or optical cards, flash memory, cache memory, and other type of media/machine-readable medium suitable for storing machine-executable instructions.

The output 104 outputs information in one or more forms including: visual, audible and/or haptic form. The output 104 may be controlled by the controller 101 to provide outputs to the user of the occupant monitoring apparatus 100. The output 104 may include one or more from among a speaker, audio, a display, a centrally-located display, a head up display, a windshield display, a haptic feedback device, a vibration device, a tactile feedback device, a tap-feedback device, a holographic display, an instrument light, an indicator light, etc.

The output 104 may output notification including one or more from among an audible notification, a light notification, and a display notification. The notification may include information notifying of the activation or deactivation of the occupant monitoring apparatus 100. The output 104 may also display image and information provided by one or more sensors 105.

The sensor 105 may include one or more from among a camera, a video camera and, an imaging sensor. The sensor 105 may be a high dynamic resolution enabled sensor or non-linear sensor (e.g., a logarithmic response sensor) for managing a larger dynamic range. The sensor 105 may be equipped with a pixel level polarization filter. The sensor 105 may have a voltage controlled device that allows for time modulation of the polarization orientation of the modulated polarized phase shifter, provided a fixed orientation polarizer is mounted on the sensor.

The user input 106 is configured to provide information and commands to the occupant monitoring apparatus 100. The user input 106 may be used to provide user inputs, etc., to the controller 101. The user input 106 may include one or more from among a touchscreen, a keyboard, a soft keypad, a button, a motion detector, a voice input detector, a microphone, a camera, a trackpad, a mouse, a touchpad, etc. The user input 106 may be configured to receive a user input to acknowledge or dismiss the notification output by the output 104. The user input 106 may also be configured to receive a user input to activate or deactivate the occupant monitoring apparatus 100.

The illuminator 107 may be a laser source at a fixed orientation and may include one or more from among a polarized filter and a modulated polarized phase shifter. The modulated polarized phase shifter may adaptively adjust the illumination polarization orientation in coordination with the sensor 105 to maximize the illumination to background ratio. The wavelength of the illuminator 107 may be wavelength whose atmospheric absorption is high to reduce the contribution from the ambient light. For example, the illuminator 107 may emit a laser with a wavelength between 900 nm and 950 nm, or may emit a laser with a wavelength of about 1550 nm.

The illuminator 107 may include a voltage-controlled device that is configured to time modulate the emitted light. An example of voltage-controlled device is a liquid crystal wave plate. By adjusting the source polarization orientation relative to the sensor 105, the signal to background ratio can be optimized. The illuminator 107 including a time varied polarized laser source when combined with either a single polarization filter or a sensor including pixel level polarization filter can be used to dynamically select the best signal to background images under varying ambient lighting conditions.

The communication device 108 may be used by occupant monitoring apparatus 100 to communicate with several types of external apparatuses according to various communication methods. The communication device 108 may include various communication modules such as one or more from among a telematics unit, a broadcast receiving module, a near field communication (NFC) module, a GPS receiver, a wired communication module, or a wireless communication module. The broadcast receiving module may include a terrestrial broadcast receiving module including an antenna to receive a terrestrial broadcast signal, a demodulator, and an equalizer, etc. The NFC module is a module that communicates with an external apparatus located at a nearby distance according to an NFC method. The GPS receiver is a module that receives a GPS signal from a GPS satellite and detects a current location. The wired communication module may be a module that receives information over a wired network such as a local area network, a controller area network (CAN), or an external network. The wireless communication module is a module that is connected to an external network by using a wireless communication protocol such as IEEE 802.11 protocols, WiMAX, Wi-Fi or IEEE communication protocol and communicates with the external network. The wireless communication module may further include a mobile communication module that accesses a mobile communication network and performs communication according to various mobile communication standards such as 3^{rd} generation (3G), 3rd generation partnership project (3GPP), long-term evolution (LTE), Bluetooth, EVDO, CDMA, GPRS, EDGE or ZigBee.

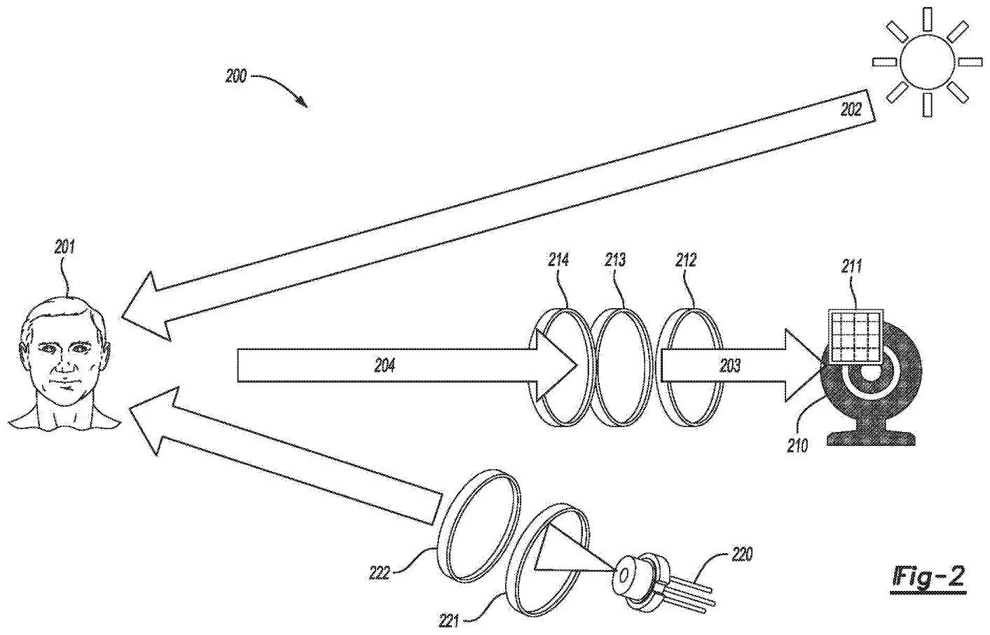

FIG. 2 shows an illustration of an occupant monitoring apparatus according to an exemplary embodiment.

Referring to FIG. 2, an occupant 201 of a space such as a vehicle may be illuminated by ambient light 202 from a source such as the sun. The ambient light, depending on its intensity and the position of the ambient light source, may interfere with detection of the occupant by a sensor. However, the occupant monitor system 200 shown in FIG. 2 is equipped with devices configured to address and/or mitigate the issues caused by the ambient light 202.

The occupant monitor system 200 may include sensor 210. The sensor 210 include one or more from among an imaging sensor, camera, video camera, etc. The sensor 210 may be a high dynamic resolution enabled sensor or non-linear sensor (e.g., a logarithmic response sensor) for managing a larger dynamic range. The sensor 210 may be equipped with a pixel level polarization filter 211. In one example, the pixel level polarization filter 211 may be built into a CMOS sensor, on a chip level architecture, and perform polarization filtering per pixel so that each individual pixel collects light only from a specific polarization orientation. According to an aspect of an example, three distinct polarization states or orientations may be used to determine the degree of polarization of any light. Based on the three distinct polarization states, the pixel array can be minimally defined by three unique polarization filter orientations arranged in a super pixel consisting or comprising of the three orientations. For redundancy, four orientations may be selected and thus the super pixel may be made up of four sub pixels. The orientations of the polarization filter at the pixel may include a first pixel with 0 degree polarization filter, a second pixel with 45 degree polarization filter, a third pixel with 90 degree polarization filter, and a fourth pixel with 135 degree polarization filter.

The sensor 210 may be configured to receive reflected light 204. The reflected light 204 is reflected off occupant 201 and may be light emitted 203 by illuminator 220 (i.e., emitted light 203). The reflected light 204 may be received by the sensor 210 through a narrow band spectral filter 214, a modulated polarized phase shifter 213, and a polarized filter 212. The modulated polarized phase shifter 213 may be disposed in between the narrow band spectral filter 214 and the polarized filter 212.

The narrow band spectral filter 214 may be an optical device such as a multi-layer lens or coating that creates destructive interference for wavelengths outside the desired light frequency region, thereby preventing unwanted wavelengths of night from passing and allowing wavelengths of light in a region of interest to pass with minimal attenuation. The narrow band spectral filter 214 may be designed for filter performance and cut to a particular size. For less demanding designs, filters can also be designed based upon absorption characteristics to prevent certain wavelengths of light to pass. However, absorption devices may have very wide (100's of nm) bandpass characteristics.

The modulated polarized phase shifter 213 is a device that has a voltage drive source that when modulated will alter the phase of the light transmitted through the device. The modulated polarized phase shifter 213 may also be configured to reflect light. The phase shift is manifest in the polarization orientation of the transmitted beam relative to the input beam orientation. By driving the voltage signal, the signal may be modulated at very high speeds (e.g., GHz) or modulated at lower frequencies (e.g., 10 to 1000 Hz).

The polarized filter 212 may be a filter that only allows a particular polarization orientation of light to pass through. The combination of the narrow band spectral filter 214, a modulated polarized phase shifter 213, and a polarized filter 212 may be operated in a situation where random polarized light of a wide spectral nature is incident to the three devices in the following order; narrow band spectral filter 214, a modulated polarized phase shifter 213, and a polarized filter 212. The narrow band spectral filter 214 to act to reduce the incident light to a narrow spectral region of interest. The modulated polarized phase shifter 213, assuming it is selected to have a temporal band width sufficiently faster than a frame rate of the imaging sensor, may be operated to change the incident light polarization phase relative to the polarized filter 212 located after modulated polarized phase shifter 213. Thus, only light of the co-aligned polarized state can pass the filter and reach the sensor. This combination of devices, with light reflected from the driver that can be distinguished from the light reflected from other objects not of interest to the DMS system, would improve the signal to noise ratio of the system.

The illuminator 220 may be a laser source at a fixed orientation and may emit a laser or light through one or more from among a polarized filter 221 and a modulated polarized phase shifter 222 at the occupant 201. As described above, with the additional feature that the manipulation of the polarized state of light is now being applied to the light source illuminator. A laser light source allows for this manipulation to be carried out very efficiently because laser light by nature is polarized and generally in a very narrow region of wavelengths. Thus, manipulation of the polarization orientation is possible by the same devices as previously mentioned. The polarized filter 221 may be disposed in between the modulated polarized phase shifter 222 and the illuminator 220 and may selectively sample a single polarization orientation. The modulated polarized phase shifter 222 may adaptively adjust the illumination polarization orientation in coordination with the sensor to maximize the illumination to background ratio. In this scenario, the frame rate of the sensor may be synchronized with or correspond to the timing of the polarization phase shift modulator.

The wavelength of the illuminator 220 may be wavelength whose atmospheric absorption is high to reduce the contribution from the ambient light. The illuminator 220 may emit a laser with a wavelength between 940 nm and 1550 nm, or may emit a laser with a wavelength between 900 nm and 950 nm, or may emit a laser with a wavelength of about 1550 nm. By using a laser as a light source for the illuminator 220, the ambient illumination can be reduced by using a narrow spectral filter centered around the central emission wavelength of the laser. In one example, the ambient illumination can be reduced by up to 60% by switching from a 35 nm bandwidth source to 4 nm bandwidth.

The illuminator 220 may include a voltage-controlled device that is configured to time modulate the emitted laser light. An example of voltage-controlled device is a liquid crystal wave plate. By adjusting the source polarization orientation relative to the sensor, the signal to background ratio can be optimized. The time varied polarized laser source when combined with either a single polarization filter or a sensor including pixel level polarization filter 211 can be used to dynamically select the best signal to background images under varying ambient lighting conditions. Alternatively, the imaging channel of the sensor 210 may have a voltage-controlled device that allows for time modulation of the polarization orientation of the modulated polarized phase shifter 213, provided a fixed orientation polarizer is mounted on the sensor. This can work in conjunction with the alternating polarization modulation on the illumination channel.

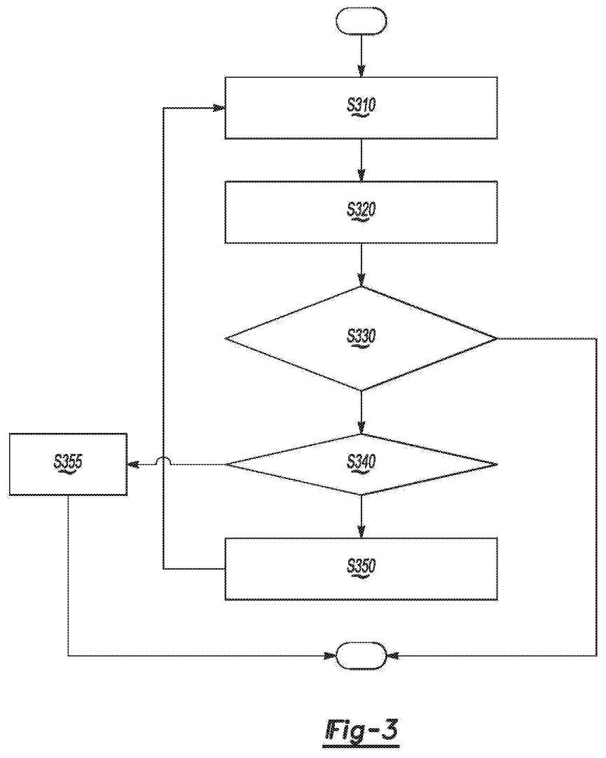

FIG. 3 shows a method to perform occupant detection and gaze tracking using the occupant monitoring apparatus according to an aspect of an exemplary embodiment.

Referring to FIG. 3, a first image corresponding to a known polarization state of the illuminator and sensor is recorded in operation S310. In operation S320, the signal to background ration of the image is measured. Then, in operation S330, it is determined if the measured ratio is above a preset threshold ratio. If the measured ratio is above a preset threshold ratio (Operation S330—YES), the process ends.

If the measured ratio is below a preset threshold ratio (Operation S3306—NO), it is determined whether an adjustment limit is reached in operation S340. If the adjustment limit is reached, for example when the measured ratio has been taken using all the possible adjustments from a set of predefined polarization and illuminator intensity combinations (Operation S340—YES), an estimate of the orientation of the gaze is used in operation S355. In this case the estimate may include an estimate of the pitch, yaw and roll angles of the current head pose based on the assumption that the passenger is looking straight forward. If the adjustment limit is not reached (Operation S340—NO), the polarization state and intensity of the illuminator are adjusted and the process restarts by recording another image corresponding to the known adjusted polarization and intensity of the illuminator and repeating operations S320-S350 until the process ends.

The processes, methods, or algorithms disclosed herein can be deliverable to/implemented by a processing device, controller, or computer, which can include any existing programmable electronic control device or dedicated electronic control device. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

One or more exemplary embodiments have been described above with reference to the drawings. The exemplary embodiments described above should be considered in a descriptive sense only and not for purposes of limitation. Moreover, the exemplary embodiments may be modified without departing from the spirit and scope of the inventive concept, which is defined by the following claims.

1. An occupant monitoring apparatus, the apparatus comprising:
a laser illuminator configured to emit a laser through one or more from among a polarized filter and a modulated polarized phase shifter to illuminate an occupant; and
a sensor configured to generate an image of the occupant illuminated by the laser.

2. The apparatus of claim 1, further comprising a controller configured to perform detection of the occupant and gaze tracking based on the image generated by the sensor.

3. (canceled)

4. The apparatus of claim 1, wherein the laser illuminator is configured to transmit the laser light through the one or more from among the polarized filter and the modulated polarized phase shifter to the occupant.

5. The apparatus of claim 1, wherein the sensor further comprises one or more from among a narrow band spectrum filter and a modulated polarized phase shifter.

6. The apparatus of claim 5, wherein the sensor is configured to receive the laser light reflected off the occupant through the one or more from among the narrow band spectrum filter and the modulated polarized phase shifter.

7. The apparatus of claim 1, wherein the laser illuminator emits the laser with a wavelength of about 1550 nm.

8. The apparatus of claim 1, wherein the laser illuminator emits the laser with a wavelength between 900 nm and 950 nm.

9. The apparatus of claim 1, wherein the sensor comprises one or more from among a high dynamic resolution image sensor and a logarithmic sensor.

10. The apparatus of claim 1, wherein the sensor comprises one or more from among a polarized filter and a pixel level polarization filter.

11. An occupant monitoring apparatus, the apparatus comprising:
a laser illuminator configured to emit a laser to illuminate an occupant; and
a sensor configured to generate an image of the occupant illuminated by the laser; and
a controller configured to:
control the sensor to record an image, the image corresponding to a known polarization state of an illuminator and a sensor;
measure the signal to background noise ratio of the recorded image;
determine whether the signal to background noise ratio of the recorded image is above a predetermined threshold ratio;
in response to determining that the signal to background noise ratio is at or above the predetermined threshold, perform occupant detection and gaze estimation using the recorded image;
in response to determining that the signal to background noise ratio is below the predetermined threshold, determine whether an adjustment limit is reached; and
in response to determining that the adjustment limit has not been reached, control to adjust one or more from among polarization state and intensity of the illumination from the laser illuminator.

12. The apparatus of claim 11, wherein a controller further configured to, in response to determining that the adjustment limit is reached, use head pose as an estimate of a gaze direction of the occupant.

13. The apparatus of claim 11, wherein the laser illuminator further comprises one or more from among a polarized filter and a modulated polarized phase shifter.

14. The apparatus of claim 13, wherein the laser illuminator is configured to transmit the laser light through the one or more from among the polarized filter and the modulated polarized phase shifter to the occupant.

15. The apparatus of claim 11, wherein the sensor further comprises one or more from among a narrow band spectrum filter and a modulated polarized phase shifter.

16. The apparatus of claim 15, wherein the sensor is configured to receive the laser light reflected off the occupant through the one or more from among the narrow band spectrum filter and the modulated polarized phase shifter.

17. The apparatus of claim 11, wherein the laser illuminator emits the laser with a wavelength of around 1550 nm.

18. The apparatus of claim 11, wherein the laser illuminator emits the laser with a wavelength between 900 nm and 950 nm.

19. The apparatus of claim 11, wherein the sensor comprises one or more from among a high dynamic resolution image sensor and a logarithmic sensor.

20. The apparatus of claim 11, wherein the sensor comprises one or more from among a polarized filter and a pixel level polarization filter.
